(19) United States
(12) Patent Application Publication
(10) Pub. No.: US 2009/0084617 A1
(43) Pub. Date: Apr. 2, 2009

(54) Integrated reminder function in a personal mobility vehicle, such as a wheelchair

(75) Inventors: Matthias Holenweg, Buren an der Aare (CH); Michel Cavatorta, Bettlach (CH)

Correspondence Address: HARRINGTON & SMITH, PC, 4 RESEARCH DRIVE, Suite 202, SHELTON, CT, 06484-6212, US

(73) Assignee: Curtis Instruments, Inc.

(21) Appl. No.: 11/906,405

(22) Filed: Oct. 1, 2007

(51) Int. Cl. B60K 1/00; G06F 17/00

(52) U.S. Cl. 180/65.1; 701/22

(57) ABSTRACT

A personal mobility vehicle, such as a wheelchair system, includes a user interface having a user input and a display for displaying information to the user and a control unit that includes a data processor and a memory. The data processor is responsive to the user entering information into the personal mobility vehicle, where the information is indicative of a reminder to be generated upon the occurrence of a triggering event, to store the information and to present the reminder, upon an occurrence of the triggering event, to the user on the user interface of the personal mobility vehicle. The information can include a message text, and the triggering event may be one of the elapsing of a specified interval of time or an occurrence of a specified time of day. The reminder may be presented by generating at least one of text, an image, a pictogram, an animation and sound.

### TECHNICAL FIELD

The exemplary embodiments of this invention relate generally to personal mobility vehicles such as wheelchairs, and more specifically relate to automated control systems and user interfaces for such vehicles.

### BACKGROUND

Self-powered personal mobility vehicles, such as wheelchairs having a self-contained power source to provide drive power to wheels and steering actuators, may include a data processor subsystem to control the various power and motive subsystems of the vehicle, as well as to implement a user interface function enabling an occupant of the vehicle to control the overall operation of the vehicle, such as to start, stop and steer the vehicle.

Wheelchairs need to be periodically inspected and maintained, such as after some predetermined amount of time or after having been driven for some predetermined distance.

A wheelchair user may spend most of the day in the wheelchair. These users typically also need to schedule events other than wheelchair maintenance events. These event can include daily events, such as taking medication, or weekly or monthly events such as keeping an appointment with a physician or a physical therapist. In conventional practice the wheelchair user needs to keep some type of diary, and possibly an alarm clock, to be reminded of scheduled events, and/or the user needs to rely on another person for reminders of scheduled events.

The exemplary embodiments of this invention are directed to improvements in these and similar types of personal mobility vehicles.

### SUMMARY

The foregoing and other problems are overcome, and other advantages are realized, in accordance with the presently preferred embodiments of this invention.

In a first aspect thereof the exemplary embodiments of this invention provide a method to operate a personal mobility vehicle that comprises a user entering information into the personal mobility vehicle that is indicative of a reminder to be generated upon the occurrence of a triggering event and, upon the occurrence of the triggering event, presenting the reminder to the user of the personal mobility vehicle on a user interface of the personal mobility vehicle.

In a further aspect thereof the exemplary embodiments of this invention provide a personal mobility vehicle having a user interface that comprises a user input and a display for displaying information to the user, and that further includes a control unit that comprises a data processor and a memory. The data processor is responsive to the user entering information into the personal mobility vehicle, where the information is indicative of a reminder to be generated upon the occurrence of a triggering event, to store the information and to present the reminder, upon an occurrence of the triggering event, to the user on the user interface of the personal mobility vehicle.

In another aspect thereof the exemplary embodiments of this invention provide a memory medium that tangibly stores a computer program for execution by a data processor to implement a user interface of a wheelchair system by operations that comprise, in response to a user entering information into the wheelchair system that is indicative of a reminder to be generated upon the occurrence of a triggering event, storing the information and, upon the occurrence of the triggering event, presenting the reminder to the user of the wheelchair system on the user interface of the wheelchair system.

### BRIEF DESCRIPTION OF THE DRAWINGS

The foregoing and other aspects of the presently preferred embodiments of this invention are made more evident in the following Detailed Description of the invention, when read in conjunction with the attached Drawing Figures, wherein:

FIG. 1A is an elevational view of an embodiment of a personal mobility vehicle that is suitable for implementing the exemplary embodiments of this invention.

FIG. 1B shows in greater detail a user interface portion of the vehicle of FIG. 1A.

FIG. 2 is a simplified block diagram of a wheelchair system controller in accordance with the exemplary embodiments of this invention.

FIG. 3 is a simplified block diagram of the user interface portion shown in FIG. 1B.

FIG. 4 depicts an exemplary menu tree that may be displayed on a programming tool or station, such as a personal computer screen.

FIG. 5 depicts an exemplary menu tree that may be displayed to a user.

### DETAILED DESCRIPTION

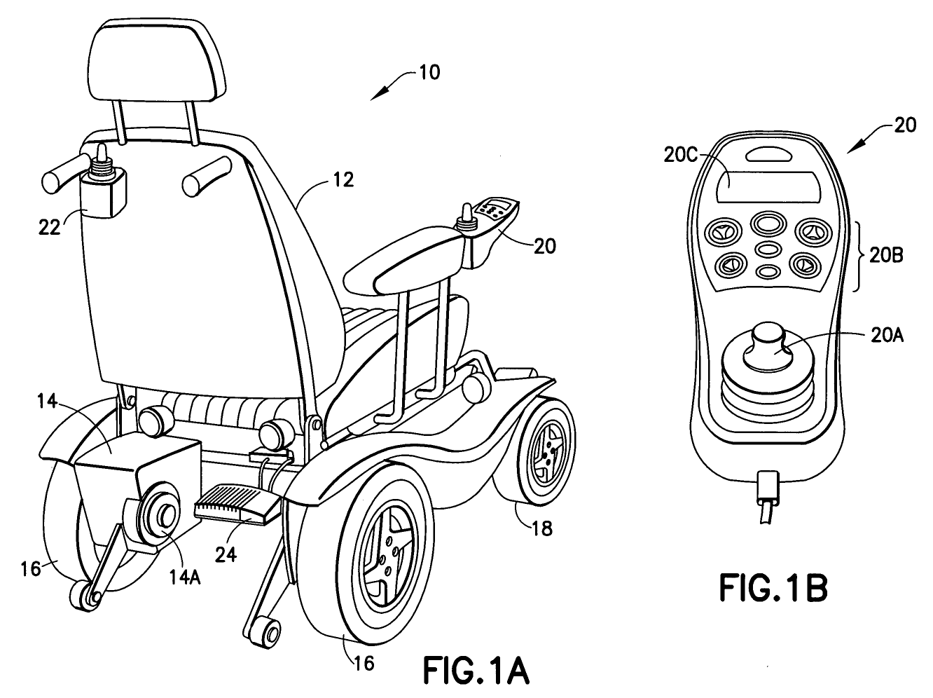

Before describing the exemplary embodiments of this invention in detail reference is first made to FIG. 1A for showing a rear elevational view of an embodiment of a personal mobility vehicle that is suitable for implementing the exemplary embodiments of this invention, as well as to FIG. 1B that shows in greater detail a user interface portion of the vehicle of FIG. 1A. In the embodiment shown in FIGS. 1A and 1B the personal mobility vehicle is embodied as a wheelchair system 10, although this is not a limitation upon the use and practice of the exemplary embodiments of this invention. As employed herein a wheelchair system is considered as a vehicle capable of controlled, self-powered (e.g., battery powered) movement for a sitting person.

The wheelchair system 10 includes a seat portion 12, a power source 14, such as a battery and related power conversion, conditioning and recharging circuitry, and at least two wheels 16 that are driven by the power source 14 via at least one motor 14A. One or more other wheels 18 provide stability and enable steering of the wheelchair system 10. In this regard there is a user interface 20, embodied in this example as a user-actuated hand control system 20 that may include a joystick type controller 20A, a plurality of buttons 20B, and a display 20C, such as an LCD, LED or other suitable type of display system. An attendant control system 22 may also be provided. The user interface 20 operates with a control system of controller 24 to provide functions that include, but need not be limited to, starting and stopping motive power to the drive wheels 16, controlling the direction of rotation and speed of rotation of the drive wheels 16, and controlling a pointing direction of the wheels 18 to provide steering of the wheelchair 10.

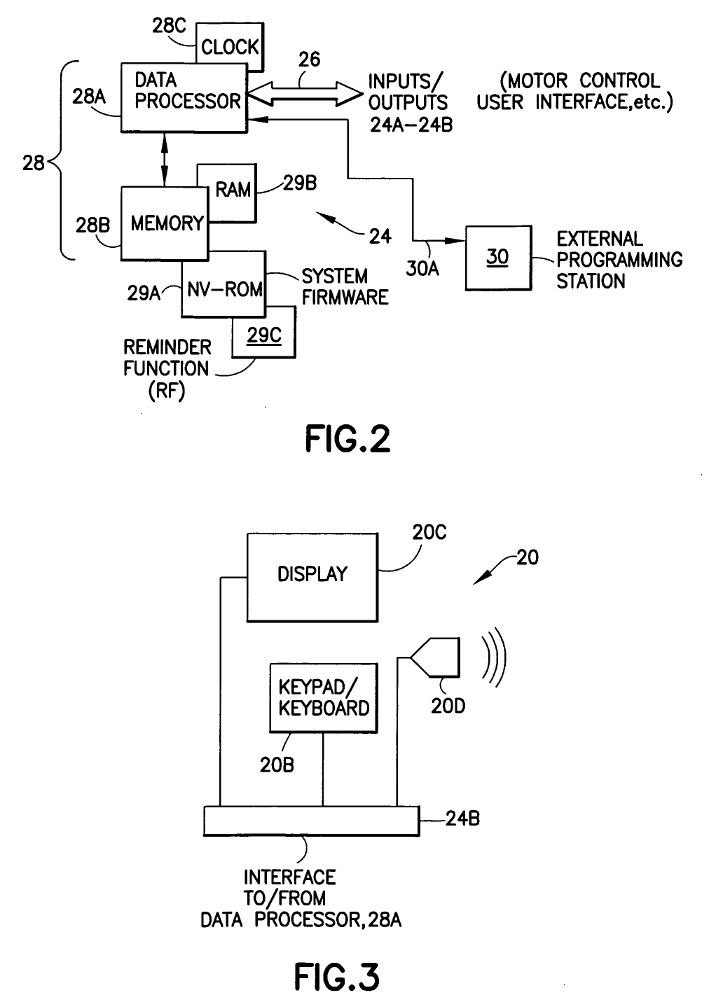

FIG. 2 shows a simplified block diagram of a portion of the controller 24. The controller 24 can be assumed to include a software system 28 that includes at least one data processor 28A, such as a microprocessor or microcontroller, and a memory 28B that stores programs to control operation of the data processor 28A and, thereby, to control the overall operation of the wheelchair 10. The operating programs may be considered to be firmware, such as computer programs that are permanently stored in, by example, non-volatile read only memory (NV-ROM) 29A, as opposed to possibly volatile random access memory (RAM) 29B that is loaded from a disk or some other type of memory storage medium. However, the exemplary embodiments of this invention are also usable with a system where an operating control program is stored in a mass memory device, such as a disk, and loaded into RAM as needed.

The data processor 28A is coupled via general use input/output hardware 26 to various input/outputs, including general input/outputs, such as input/outputs 24A going to and from the user interface 20 and inputs/outputs 24B providing control to the motor(s) 14A. The software system 28 may include a clock function or module 28C for maintaining an accurate time of day and calendar function. Of most interest to the description of this invention is the interactivity of the data processor 28A with the user interface 20 to provide an automated reminder functionality for the user of the wheelchair system 10.

FIG. 3 shows a portion of the user interface 20 in greater detail. The user interface 20 includes the keypad/keyboard 20B, the display 20C and possibly an acoustic transducer 20D to provide auditory alerts to the user. In one exemplary embodiment the display 20C may be a touch sensitive display, and in this case the keypad/keyboard 20B may not be needed.

The exemplary embodiments of this invention provide a reminder function (shown as a software module RF 29C in FIG. 2) that is integrated into the electrical wheelchair system 10 or some other type of personal mobility vehicle. The RF 29C system is enabled to show information to the user using the display 20C or by using some other suitable means. The RF 20C enables the integration of a “pop-up” function into the wheelchair system 10 that enables the user to enter reminders for any kind of events (e.g., appointment with a therapist, a reminder to take a medication) without needing to rely on another device, or on another person.

Prior to this invention such reminder functionalities (e.g., user interface for entering reminders (of scheduled events), user interface for receiving notifications of scheduled events, clock/calendar function) were not integrated into the wheelchair system 10.

The reminder function 29C thus provides the possibility to remind the user to perform some actions, and this case be accomplished through the use of the display 20C (via a pop-up screen) and/or the acoustic transducer 20D.

The pop-up screen shows the necessary information to the user. This information can take many forms, such as text (a message text), an image, a pictogram, an animation with or without sound, or by sound alone. The reminder pop-up and sound may be programmed using a programming tool or station, and the event, which triggers the reminder, may be programmed with the programming tool and/or through the user interface 20. The reminder can be triggered based on time, interval, distance traveled, or any other event in the wheelchair system 10. The programming tool may be the user interface 20 and/or an external device or programming station 30 such as an application running on a personal computer (PC), a laptop, or a personal digital assistant (PDA), and a programming interface 30A to the data processor 28A may be a wired or a wireless (e.g., Bluetooth™) interface.

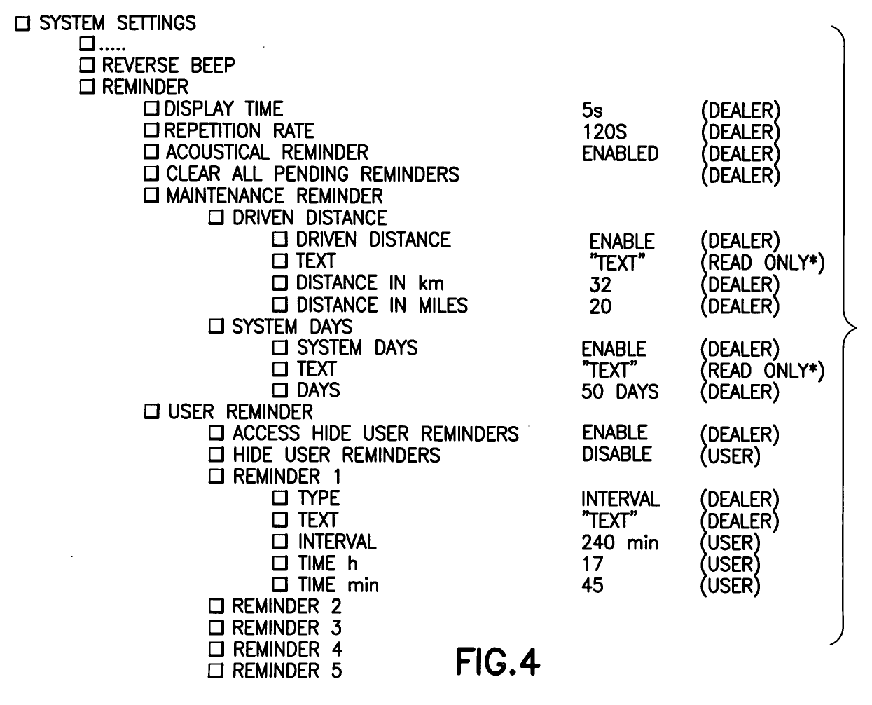

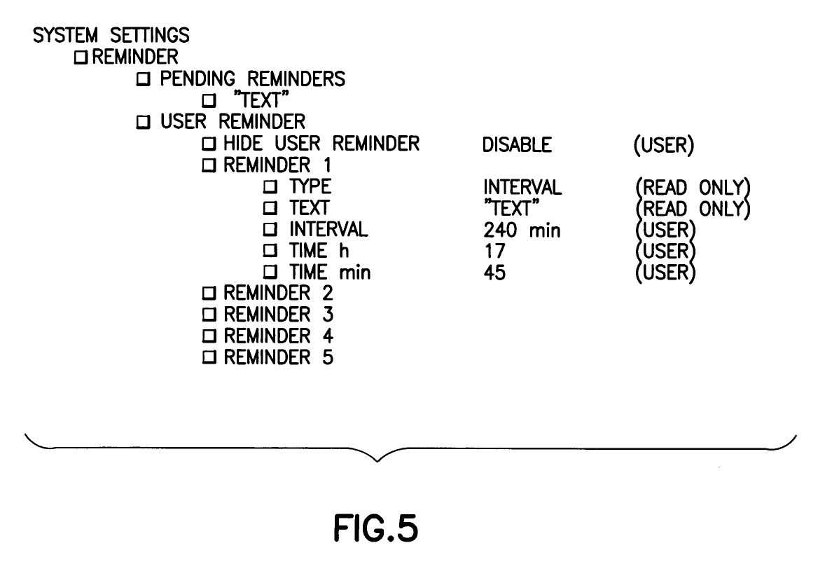

FIG. 4 shows a non-limiting example of a menu tree that can be used for implementing the exemplary embodiments of this invention using the external programming tool or station 30, such as a personal computer, while FIG. 5 shows an exemplary menu tree that may be displayed to the user on the display 20C. In FIG. 5 the “Text” item under “pending Reminders” implies that a detail screen shows the text and the time where the reminder was the first to be displayed. In addition it may show how the user is to confirm the reminder (e.g., movement forward).

The reminder function 29C offers the possibility to remind the user to perform some task via the user interface 20, such as by the use of a pop-up on the display screen 20C and/or using the acoustic transducer 20D.

The reminder function 29C may be considered to have two major components, one related to maintenance of the wheelchair system 10 (Maintenance Reminders) and another one related to the user's personal needs (User Reminders). The scheduling of the occurrence of the reminder, and the pop-up text (or other information) that appears (and/or the sound that is created) may be programmed using the PC programming station 30 and/or some other suitable device.

### Maintenance Reminders

These reminders are used to indicate that maintenance should be performed for the wheelchair system 10. The text for these Maintenance Reminders may be programmed with the PC programming station 30. The ability to enable/disable these reminders, and schedule their occurrence, may be performed with a handheld programmer or by some other means, preferably by the dealer or vendor of the wheelchair system 10.

As employed herein all references to a “dealer” are intended to generally refer to the person or organization responsible for maintenance of the wheelchair system 10, who may or may not be the actual dealer from which the wheelchair system 10 was purchased or leased.

There may be two programmable intervals, Driven Distance and System Days. The Driven Distance may be expressed in kilometers, with an exemplary range of 1 to 1000 km in 5 km steps, and may be enabled/disabled. The Driven Distance may be expressed in miles, with an exemplary range of 1 to 1000 miles in 5 mile steps, and may be enabled/disabled. The dealer may also have the possibility to program the distance. As soon as the programmed distance is reached, the associated reminder is displayed (pops-up) on the display screen 20C of the wheelchair system 10 and provides the user the pre-programmed information. With each additional multiple of the programmed distance a new pop-up appears.

Note that this embodiment may assume, as a non-limiting example, that the data processor 28A is provided an input from the motor drive sub-system, where the data processor 28A is enabled to count revolutions of the wheels 16 and convert same to distance traveled. The input may also be provided directly from an output of an odometer unit that forms a part of the motor drive sub-system.

The System Days may be expressed, by example, with a range of 1 to 1000 days in 1 day steps, and may be enabled/disabled. The dealer has the possibility to program a number of days. As soon as this amount of time has passed, a reminder pop-up provides the user with the pre-programmed information. With each additional multiple of the programmed number of days expiring a new pop-up appears. In this case, whether the wheelchair system 10 is actually driven, the days are counted. That is, the clock function 28C continues to operate whether the wheelchair system 10 is being used or is not being used.

### User Reminders

The User Reminders are employed to indicate information or “reminders” to the use of the wheelchair system 10. The message text for these reminders may be programmed with the PC programming station 30, or by using the user interface 20 (depending on the input capabilities of the user interface 20). There may be generic texts that are provided, and an ability to enable/disable User Reminders and to set an appropriate range/time for triggering the reminders can be accomplished by the user.

There may be two programmable functions: Interval and Time. The Interval function (expressed in, for example, minutes with a range of 5 min to 1440 min, in 5 min steps, and the dealer (or the user) may also have the ability to enable/disable the Interval function. The dealer (or the user) may enter a time hh:mm, with a range of 00:05 to 23:55 in 5 min steps. When the programmed interval of time elapses the pop-up reminder appears and provides the user with the pre-programmed information. This pop-up preferably is continually generated (unless disabled) each time the programmed period of time elapses.

The Time function may be expressed in hh:mm, with a range 00:05 to 23:55 in 5 min steps, and can be enabled/disabled. The user has the ability to program a specific time of day, and when the programmed time occurs the reminder is generated and provides the user the pre-programmed information. Unless disabled, the reminder is generated each day at the programmed time.

The following definitions apply in general to the Reminder Function 29C.

### Programmable Text

The use of the PC programming station, or other suitable programming tool, offers the possibility to program several texts to be used for reminders. A particular text may be linked to a programmed reminder, and if the reminder is enabled it pops up a screen to at the appropriate time. The screen shows either the linked text or a default text. Examples of default texts may include, for the Maintenance Reminder: “Your chair is due for maintenance. Please call to schedule.”

The User Reminder may have the following default text: “Reminder”, which may be replaced by a more informative linked text.

There are several possible parameters that can be associated with reminders. One is a Reminder Display Time, expressed in seconds with a range of 1 to 30 seconds in 1 second step and a default value of 5 seconds, defines how long the reminder is shown on the display screen 20C. After this time, the reminder disappears. The reminder pop-up is displayed, regardless of the actual screen. All functionality is maintained while the Reminder pop up is displayed.

Another parameters is a Reminder Repetition Rate, expressed in minutes with a range of 1 to 6.0 minutes in 1 minute steps and a default value of 1 minute, where a value of zero 0 disables the reminder repetition. In this case, if the user does not confirm or acknowledge the reminder it repeats at the programmed repetition rate. The user may be able to confirm the reminder by going into the main menu entry “pending reminders”, selecting the reminder, and confirming it by using some type of user input, including the use of the joystick 20A and/or use of a movement-related button 20B (e.g., forward). As soon as the reminder is confirmed, it disappears from the reminder list. This mode of operation is preferably applicable only to User Reminders, not for the Maintenance Reminders. These Reminders stay in the list, but are not repeated. The dealer has the possibility to clear them (see clear all pending Reminders). Preferably only the latest User Reminder of a particular category is kept in the pending reminder list. For example, if an interval reminder is set to 30 minutes, and there are already three reminders not confirmed, only the latest is kept in the pending reminders list.

Another parameter relates to acoustical reminders (those using the acoustic transducer 20D, and enables these reminders to be enabled and disabled. As one example, as long as a reminder pop up appears on the display screen 20C a double beep can be generated and repeated every 4 seconds.

Another possible parameters is a Hide User Reminders parameter, which enables or disables operation of the User Reminders. By the use of this parameter the user has the option to disable all User Reminder by setting the parameter Hide User Reminders to enable. If this parameter is set to enable, all user reminders are disable and will not appear and are not stored. If this parameter is set to disabled, the User Reminder(s) are generated and displayed to the user.

Another parameter is a Clear All Pending Reminders parameter.

Another parameter is a Missed Reminder parameter. For example, if a reminder is missed (e.g., the wheelchair system 10 was switched off or otherwise not in service when the reminder should have been generated), the last missed reminder is shown after the wheelchair system 10 is again powered on or otherwise brought back into service. If several reminders are missed from the same categories, it may be the case that only the last missed reminder is shown. If more than one reminder is missed from different categories, for example, an Interval and a Time Reminder, then both may be shown, and the most recent missed reminder is shown first.

In the various embodiments disclosed above it can be appreciated that the data processor 28A stores the entered programming data (e.g., message texts, triggering events such as elapsed time and time of day, etc.) in the memory 28B, such as in a non-volatile portion thereof.

It should be noted that as used herein the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but some examples, the use of exemplary embodiments of this invention are not limited to wheelchairs, but could encompass other type of mobility systems including, but not limited to, golf carts, forklifts and certain all terrain vehicles.

Further, the user interface 20 may be implemented at least in part using voice recognition technology to enter user information, and the acoustic transducer 20D may present synthesized speech to the user, as opposed to the use of a visual display. That is, the technical specifics of the user input/output may vary widely depending on the physical capabilities of the user, and any suitable type of user input/output biometric means may be employed to implement the exemplary embodiments of this invention.

However, all such and similar modifications of the teachings of this invention will still fall within the scope of the embodiments of this invention.

Furthermore, some of the features of the preferred embodiments of this invention may be used to advantage without the corresponding use of other features. As such, the foregoing description should be considered as merely illustrative of the principles, teachings and embodiments of this invention, and not in limitation thereof.

What is claimed is:

1. A method to operate a personal mobility vehicle, comprising:
a user entering information into the personal mobility vehicle that is indicative of a reminder to be generated upon the occurrence of a triggering event; and
upon the occurrence of the triggering event, presenting the reminder to the user of the personal mobility vehicle on a user interface of the personal mobility vehicle.

2. The method of claim 1, where the information comprises a message text, and where the triggering event comprises one of the elapsing of a specified interval of time or an occurrence of a specified time of day.

3. The method of claim 1, further comprising:
a dealer entering information into the personal mobility vehicle that is indicative of a reminder to be generated upon the occurrence of a triggering event; and
upon the occurrence of the triggering event, presenting the reminder to the user of the personal mobility vehicle on the user interface of the personal mobility vehicle, where the triggering event comprises one of the elapsing of a specified interval oftime or a distance traveled by the personal mobility vehicle.

4. The method of claim 1, where the reminder is repeatedly presented to the user until acknowledged by the user.

5. The method of claim 1, further comprising displaying a reminder to the user that should have been generated while the personal mobility vehicle was not in service, when the personal mobility vehicle is brought back into service.

6. The method of claim 1, where presenting the reminder comprises generating at least one of text, an image, a pictogram, an animation and sound.

7. The method of claim 1, where the personal mobility vehicle is a wheelchair system.

8. A personal mobility vehicle, comprising:
a user interface that comprises a user input and a display for displaying information to the user; and
a control unit that comprises a data processor and a memory, said data processor responsive to the user entering information into the personal mobility vehicle, where the information is indicative of a reminder to be generated upon the occurrence of a triggering event, to store the information and to present the reminder, upon an occurrence of the triggering event, to the user on the user interface of the personal mobility vehicle.

9. The personal mobility vehicle of claim 8, where the information comprises a message text, and where the triggering event comprises one of the elapsing of a specified interval of time or an occurrence of a specified time of day.

10. The personal mobility vehicle of claim 8, said data processor further responsive to a dealer entering information into the personal mobility vehicle that is indicative of a reminder to be generated upon the occurrence of a triggering event, to present the reminder, upon an occurrence of the triggering event, to the user on the user interface of the personal mobility vehicle, where the triggering event comprises one of the elapsing of a specified interval of time or a distance traveled by the personal mobility vehicle.

11. The personal mobility vehicle of claim 8, where the reminder is repeatedly presented to the user until acknowledged by the user.

12. The personal mobility vehicle of claim 8, further comprising displaying a reminder to the user, that should have been generated while the personal mobility vehicle was not in service, when the personal mobility vehicle is brought back into service.

13. The personal mobility vehicle of claim 8, where the reminder is presented by generating at least one of text, an image, a pictogram, an animation and sound.

14. The personal mobility vehicle of claim 8, where the personal mobility vehicle is a wheelchair system.

15. A memory medium that tangibly stores a computer program for execution by a data processor to implement a user interface of a wheelchair system by operations that comprise:
in response to a user entering information into the wheelchair system that is indicative of a reminder to be generated upon the occurrence of a triggering event, storing the information; and
upon the occurrence of the triggering event, presenting the reminder to the user of the wheelchair system on the user interface of the wheelchair system.

16. The memory medium of claim 15, where the information comprises a message text, and where the triggering event comprises one of the elapsing of a specified interval of time or an occurrence of a specified time of day.

17. The memory medium of claim 15, the operations further comprising:
in response to a dealer entering information into the wheelchair system that is indicative of a reminder to be generated upon the occurrence of a triggering event, storing the information; and
upon the occurrence of the triggering event, presenting the reminder to the user of the wheelchair system on the user interface of the wheelchair system, where the triggering event comprises one of the elapsing of a specified interval of time or a distance traveled by the wheelchair system.

18. The memory medium of claim 15, where the reminder is repeatedly presented to the user until acknowledged by the user.

19. The memory medium of claim 15, the operations further comprising displaying a reminder to the user that should have been generated while the wheelchair system was not in service, when the wheelchair system is brought back into service.

20. The memory medium of claim 15, where presenting the reminder comprises generating at least one of text, an image, a pictogram, an animation and sound.
